(19) United States
(12) Patent Application Publication
(10) Pub. No.: US 2026/0213828 A1
(43) Pub. Date: Jul. 23, 2026

(54) WIRELESS SENSING SYSTEM WITH COVERAGE EXTENSION USING ONE OR MORE ANALOG REPEATERS

(71) Applicant: Telefonaktiebolaget LM Ericsson (publ), Stockholm (SE)

(72) Inventors: Athanasios STAVRIDIS, Malmö (SE); Leif WILHELMSSON, Lund (SE)

(21) Appl. No.: 19/138,740

(22) PCT Filed: Feb. 16, 2023
(86) PCT No.: PCT/EP2023/053975

§ 371 Date: Jun. 13, 2025

(30) Foreign Application Priority Data
Dec. 23, 2022 (GR) 20220101076

(51) Int. Cl. H04B 7/155; H04B 17/40; H04W 16/26

(52) U.S. Cl. CPC H04B 7/15507; H04B 7/15528; H04B 17/40; H04W 16/26

(57) ABSTRACT

A wireless sensing system for detecting changes in a physical environment based on Channel State Information (CSI) is provided. The wireless sensing system includes a number of N network nodes. The first network node is a receiving node configured to detect changes in the physical environment, the i-th network node is a relaying node, i=2, . . . . N−1, and the N-th network node is a transmitting node. The i-th network node is configured to amplify a received signal from the (i+1)-th network node and send the amplified signal to the (i−1)-th network node. The first network node is configured to detect if any signal is transmitted from the second network node, estimate CSI for a channel based on the received signal from the second network node and determine whether there is a change in the physical environment based on the estimated CSI for the channel between the first and N-th nodes.

### TECHNICAL FIELD

Embodiments herein relate to a wireless radio frequency (RF) sensing system and method therein for detecting changes in a physical environment. In particular, they relate to sensing coverage extension of the wireless radio frequency (RF) sensing system.

### BACKGROUND

Wireless Radio Frequency (RF) sensing is an emerging market in the communication industry. Currently, RF sensing is under standardization in the ecosystem of the Institute of Electrical and Electronics Engineers IEEE 802.11 in the task group IEEE 802.11bf which is a new task group on wireless local area network (WLAN) sensing within the IEEE 802.11 working group. In the 3rd Generation Partnership Project (3GPP), discussions on the incorporation of sensing in the evolution of the 5^{th} generation (5G) communication network also take place. At the same time, significant research is conducted in the field of Joint Communication and Sensing (JCAS) for 6G. The commercial motivation of sensing in communication networks is justified by a large number of use cases which extent from healthcare to security, safety, entertainment, and many others.

A possible approach for sensing is via classical radar measurements. In radar terminology, the terms ‘monostatic’ and ‘bi/multi-static’ are used. Monostatic means that the transmission and reception points are the same. That is, the transmit antenna(s) is first used to transmit a sensing signal, i.e. a ‘radar pulse’, the return echo of which is then received by the same antenna(s), or alternatively, the transmission/reception antennas are separate but co-located. Bi/multi-static means that the receiving antenna(s) is not the same as the transmitting antenna and that they are in different locations. In classical radar measurements, a mono/bi/multi-static radar provides estimates regarding the presence of a target along with its range and radial velocity. Even though the use of radar in Line-of-Sight (LoS) propagation environments is very effective, its deployment in environments with strong Non-Line-of-Sight (NLOS) characteristics becomes challenging. Another approach which has the potential to overcome some of these limitations is based on measurements of Channel State Information (CSI) of the channel between a transmitter and a receiver. In this approach, inference regarding the presence of a target which is not a device, and/or any other quantity of interest is done either through using the CSI directly provided so it is possible to relate different CSI to different events or through the change of CSI at different time instances. In literature, this form of sensing is called Device-Free-Sensing (DFS). Here, the word “free” is connected with the fact that the target is not a device, and it is just present in the physical space of interest.

Similar to classical radar deployments, DFS can be done in monostatic, bistatic, or multi-static setups. In a mono-static setup, a device transmits and receives packets from which it can extract changes of CSI from which sensing can be undertaken. In a bistatic setup, a device transmits packets which are received by another device. The received packets can be used for determining CSI and for tracking the changes of CSI between the two devices. In the multi-static case, initially, one or multiple devices are transmitting packages which are received by one or multiple devices. In the next stage, the receiving devices are forwarding the measured, compressed, or processed CSI to a central device which is able to make inferences about the environment from the changes of the received CSI.

Focusing on IEEE 802.11bf, the devices involved in a sensing procedure can be Access Points Stations (AP STAs) or non-Access Point Stations (non-AP STAs), hereinafter sometimes simply referred to as APs and STAs, respectively. It is usual that the APs are more capable devices than the STAs in terms of e.g. bandwidth, processing, output power, and number of antennas. In fact, the introduction of Multi-User Multiple-Input Multiple-Output (MU-MIMO) in IEEE 802.1ac and Orthogonal Frequency Division Multiple Access (OFDMA) in IEEE 802.11ax further differentiated the capabilities of APs and STAs as one AP usually needs to serve multiple STAs. Therefore, it becomes clear that, also in sensing, one will have to deal with environments where the involved devices in a sensing procedure typically have different capabilities. Note that even though the previous argument is presented in terms of the IEEE 802.11 standard, this holds also for most of other modern standards for wireless communication systems.

It is well-known that the performance of a CSI-based, but also any other, sensing procedure depends on the level of Signal-to-Noise-Ratio (SNR) of a received signal. This is the case irrespective of whether the considered scenario is monostatic, bistatic, or multi-static. Thus, due to the signal attenuation during propagation, the coverage area of a sensing procedure is limited to the area where the SNR is sufficient high for sensing which may be significantly smaller than the coverage area for communications. As a quantitative example, communication may often be possible down to 0 dB SNR using robust modulation and powerful error correcting code, whereas sensing may require as much as 20-30 dB SNR. Consequently, sensing in a wider area, e.g., an area similar to the one where communication is possible, requires new technical solutions that overcome the coverage area limitation. In addition, even in the area where the SNR is sufficiently high, the accuracy of sensing is directly connected with the SNR of the received signal, as higher SNR results in enhanced accuracy. In addition, the resolution and/or accuracy of sensing in this area is not uniform. In fact, the resolution and/or accuracy of sensing decreases as the monitored activity is taking place in regions with lower signal power.

Therefore, technical solutions are needed for coverage extension, sensing resolution and accuracy improvement.

### SUMMARY

It is therefore an object of embodiments herein to provide a sensing system and method therein for extending the coverage area and improving the sensing accuracy and resolution. Further, it is clear, for cost purposes, that it is desirable to obtain these improvements by reusing existing infrastructure as far as possible.

According to one aspect of embodiments herein, the object is achieved by a wireless sensing system and method therein for detecting changes in a physical environment based on CSI. The wireless sensing system comprises a number of N network nodes. The first network node is a receiving or sensing node configured to detect changes in the physical environment, an i-th network node is a relaying node, where i=2, . . . . N−1, and the N-th network node is a transmitting node and configured to transmit a signal.

The i-th network node is configured to amplify a received signal transmitted from the (i+1)-th network node. The i-th network node is further configured to send the amplified signal to the (i−1)-th network node.

The first network node is configured to detect if any signal is transmitted from the second network node; and estimate CSI for a channel between the first and N-th network nodes via one or more relay nodes from the (N−1)-th network node to the second network node based on a received signal from the second network node.

The first network node is configured to determine whether there is a change in the physical environment based on the estimated CSI. That is the first network node performs sensing inferences for the estimated CSI of current instance.

In other words, embodiments herein provide an enhanced bistatic sensing system in terms of coverage area and sensing resolution. In more detail, by using existing infrastructure, i.e. by using additional existing network nodes which may or may not belong to the same network as the bistatic sensing system, the sensing coverage area of the bistatic sensing system is increased. Under the assumption of the existence of one or more additional unassociated or associated network nodes in the surrounding area of the bistatic sensing system of interest, Amplify-and-Forward (AF) relaying is used in a novel way in the one or more additional network nodes, e.g., the i-th network node.

The i-th network node may be an all-time relaying node, i.e. the i-th network node may run AF operation all the time. The i-th network node may also be a detecting and relaying node, i.e. the i-th network node may detect if any signal is transmitted from the (i+1)-th network node by measuring a received signal strength and comparing the received signal strength with a threshold. If the received signal strength is larger than the threshold, the i-th network node starts AF operation.

That is, the i-th network node is configured to amplify a received signal from the (i+1)-th network node and send the amplified signal to the (i−1)-th network node. The first network node estimates CSI for the channel between the first and N-th network nodes via one or more relay nodes from the (N−1)-th network node to the second network node based on the received signal from the second network node and determine whether there is a change in the physical environment based on the estimated CSI. The sensing network node, i.e. the first network node, will in this way effectively estimate the channel from the source network node, i.e. the N-th network node, to the sensing network node via one or more relaying nodes, so the sensing network node has enlarged the sensing area. In addition, when the additional nodes are associated with the bistatic system of interest, embodiments herein provide a solution based on AF relaying which provides enhanced sensing resolution.

Some advantages of the embodiments herein are, but not limited to:

Embodiments herein provide a sensing system with extended sensing coverage area.

Embodiments herein provide a sensing system with improved sensing resolution.

If used for dedicated sensing, rather than for communication, embodiments herein can reduce power consumption of the sensing system since the same coverage and accuracy may be obtained with a significantly reduced transmission power.

Therefore, the embodiments herein provide a sensing system with extended coverage area, improved sensing accuracy and resolution without cause extra cost by reusing existing infrastructure as far as possible.

### BRIEF DESCRIPTION OF THE DRAWINGS

Examples of embodiments herein are described in more detail with reference to the attached drawings in which:

FIG. 1 is a schematic block diagram illustrating a basic sensing system;

FIG. 2 is a schematic block diagram illustrating a sensing system with extended sensing coverage area according to embodiment herein;

FIG. 3 is a schematic block diagram illustrating a sensing system with improved sensing resolution according to embodiment herein;

FIG. 4 is a schematic block diagram illustrating a sensing system with multi-hop relaying nodes according to embodiment herein; and

FIG. 5 is a flow chart illustrating a method performed in a sensing system according to embodiments herein.

### DETAILED DESCRIPTION

In a sensing procedure, it is often important to incorporate technical solutions which increase the SNR of a received signal. According to embodiments herein, a wireless sensing system and methods therein are proposed for extending the sensing coverage of a network node where a sensing procedure is based on CSI between a sensing transmitter and a sensing receiver directly or on the temporal changes of CSI between the sensing transmitter and sensing receiver.

Also, the presentation of the disclosure is done in terms of the IEEE 802.11bf standard. However, the extension to other standards is straightforward and considered obvious for a person of ordinary skill in the art.

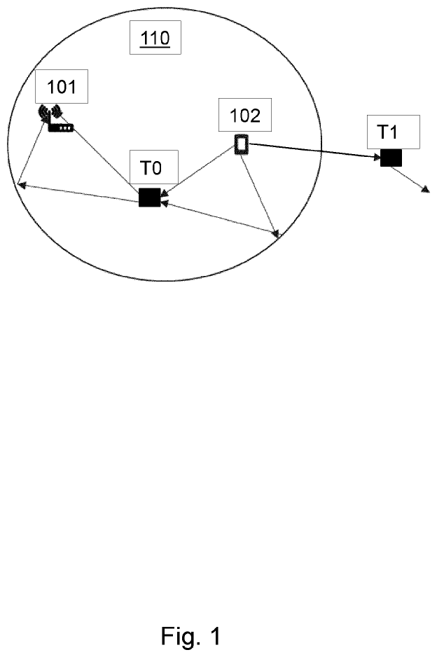

FIG. 1 shows a basic wireless RF sensing system 100. The wireless sensing system 100 comprises a sensing receiver, termed as a first network node 101. The first network node 101 aims to sense any change in the environment by measuring changes of CSI for a channel between itself and a sensing transmitter, termed as a second network node 102. It may be so that the first network node 101 is more capable than the second network node 102. For example, the first network node 101 may be an AP while the second network node 102 may be a STA. The first network node 101 needs to be able to receive, demodulate, and possibly decode a packet sent from the second network node 102. The packet may consist of a short training field (STF) for packet detection, a long training field (LTF) for measured SNR and MIMO channel estimation, and data symbols. It is emphasized that, due to the channel attenuation, the first network node 101 is able to establish a sensing coverage cell restricted in a specific physical area. For the purpose of abstract presentation, in FIG. 1, this sensing coverage cell is represented as a circle 110, however, the actual shape and size of this sensing coverage cell depends on the SNR, environment, and the required resolution of the corresponding sensing operation. The first network node 101 senses the environment by conducting measurements on the packets transmitted from the second network node 102. The circle 110 represents the sensing coverage area of the first network node 101, for which any physical change results in a CSI change which is measurable by the first network node 101.

Clearly, physical movements, presence, or absence of a target TO, which is physically located in the coverage cell 110 of the first network node 101, can be identified by the first network node 101 via the usual CSI sensing measurements of the following received signal, y₁(t), in the first network node 101:

$${y}_{1} ( t ) = {h}_{1 , 2} ( t ) * {x}_{1} ( t ) + {w}_{1} ( t ) \qquad ( 1 )$$

Where, * represents the convolution operator, h_{1,2}(t) is the channel from the second network node 102 to the first network node 101, x₂(t) is the signal transmitted from the second network node 102, and w₁(t) is the Gaussian thermal noise of the first network node 101. In contrast, for any other target, such as a target T1, which is outside the sensing coverage cell 110 of the first network node 101, has no or non-noticeable influence on the received signal y₁(t) of the first network node 101. This is the case even when the transmitted signal x₂(t) from the second network node 102 is able to reach T1. Thus, the first network node 101 is unable to perform any sensing on T1.

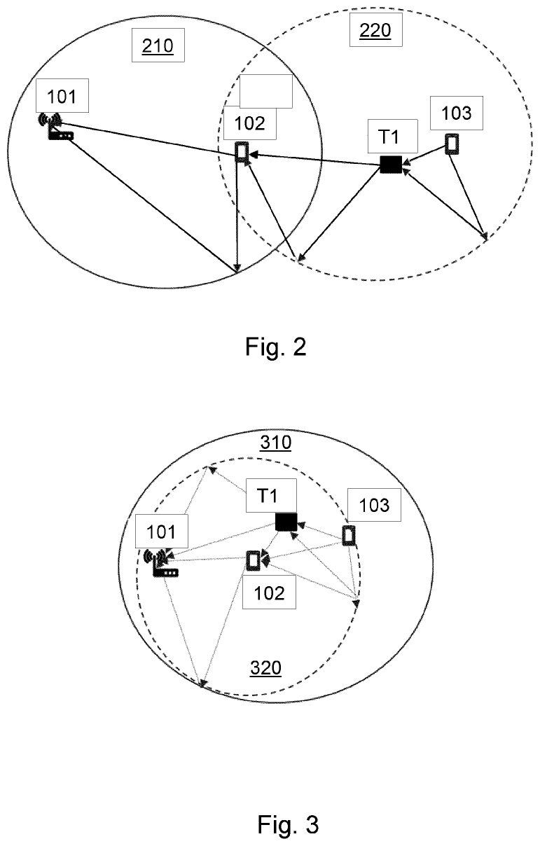

In order to overcome the sensing coverage limitation, a wireless sensing system 200 according to embodiments herein is proposed and shown in FIG. 2, where another node, such as a third network node 103, which is in close proximity with the target T1 and the second network node 102 is included in the wireless sensing system 200. Signal propagation can occur between the second and third network nodes 102 and 103. Here, the third network node 103 may be a STA or an AP. Furthermore, it may be assumed that the third network node 103 has no association with the first and second network nodes 101 and 102, i.e. there is no dedicated signal transmission between the third and first network nodes 103 and 101, and no dedicated signal transmission between the third and second network nodes 103 and 102. Such a scenario is already common, but it will become even more common as the densification of networks will further increase in the future by adding more cell sites within the existing infrastructure to increase the amount of available capacity. As shown in FIG. 2, the solid circle 210 represents the sensing coverage area of the first network node 101, while the dashed circle 220 represents the area of all possible signal propagation paths between the second network node 102 and the third network node 103. Also, no signal propagation path exists between the third network node 103 and the first network node 101. Note that the target TO is removed from FIG. 2 in order to simplify the presentation of the current disclosure.

The extension of the sensing coverage area is possible via amplify-and-forward of any signal reception in the second network node 102 from the third network node 103. The third network node 103 may be associated or not with the second network node 102. When the third network node 103 is associated with the second network node 102, sensing may be initiated on demand from the first network node 101 via an appropriated signaling. Whereas, when the third network node 103 is not associated, a sensing procedure can take place only during a transmission of a signal not intended for the second network node, like e.g. a beacon from the third network node 103, or preamble or any other known signal part, such as Long Training Field (LTF) contained in a commonly used packet.

When the third network node 103 has no association with the second network node 102, no dedicated signal transmission between these nodes can be expected. However, the third network node 103 could be associated with another AP or STA to which it could transmit packets. For example, in IEEE 802.11, each packet is self-contained, and includes a preamble. A preamble includes predetermined fields which are known to the first network node 101 and the second network node 102, such as the LTF or other training fields. In addition, apart from the dedicated packet transmission, the third network node 103 transmits beacon frames periodically. In this disclosure, it is proposed to use these signal transmissions from the third network node 103 for CSI sensing purposes in the first network node 101.

For example, upon a request from the first network node 101, the second network node 102 may listen for any transmissions from the third network node 103, e.g. a beacon frame, a packet comprising a preamble or any known signal part transmitted to another network node. Once a transmission is detected from the third network node 103, the second network node 102 adopts an Amplify-and-Forward (AF) operation and relays the received signal to the first network node 101. In more detail, this operation is expressed as:

$${y}_{2} ( t ) = {h}_{2 , 3} ( t ) * {x}_{3} ( t ) + {w}_{2} ( t ) \qquad ( 2 )$$

where, h_{2,3}(t) is the channel from the third network node 103 to the second network node 102; x₃(t) is the signal transmitted from the third network node 103, and w₂(t) is the Gaussian thermal noise of the second network node 102, and

$${y}_{1} ( t ) = {h}_{1 , 2} ( t ) * {y}_{2} ( t ) + {w}_{1} ( t ) \qquad ( 3 )$$

Equation (2) represents the signal propagation from the third network node 103 to the second network node 102, whereas equation (3) represents the signal propagation from the second network node 102 to the first network node 101. The incorporation of equation (2) into (1) gives:

$${y}_{1} ( t ) = {h}_{1 , 2} ( t ) * {h}_{2 , 3} ( t ) * {x}_{3} ( t ) + {h}_{1 , 2} ( t ) * {w}_{2} ( t ) + {w}_{1} ( t ) \qquad ( 4 )$$

Note, that the resulting virtual channel is:

$${h}_{1 , 3} ( t ) = {h}_{1 , 2} ( t ) * {h}_{2 , 3} ( t ) \qquad ( 5 )$$

which includes any propagation delay due and amplification factor used in AF operation in the second node 102. Provided the definition of:

$${\overline{w}}_{1} ( t ) = {h}_{1 , 2} ( t ) * {w}_{2} ( t ) + {w}_{1} ( t ) \qquad ( 6 )$$

and equation (5), equation (4) can be rewritten as:

$${y}_{1} ( t ) = {h}_{1 , 3} ( t ) * {x}_{3} ( t ) + {\overline{w}}_{1} ( t ) \qquad ( 7 )$$

The joint inspection of equations (1) and (7) reveals that they have the very same form. Therefore, the first network node 101 is able to directly apply any available CSI sensing technique for equation (1) in equation (7) which forming a larger sensing cell in this way. This sensing cell includes the physical area of the union of its own sensing cell and the additional coverage area provided by the second network node 102.

It is clear that the above analysis is still valid even if the third and second network nodes 103, 102 are associated. In this case, the AF sensing approach described above, may be initiated on demand from the first network node 101 via the second network node 102. This may result in a longer sensing period, and thus more accurate sensing, for the same time interval. This is because more or longer packets may be sent from the third network node 103 and used by the second network node 102 for sensing, rather than only the preamble or beacon.

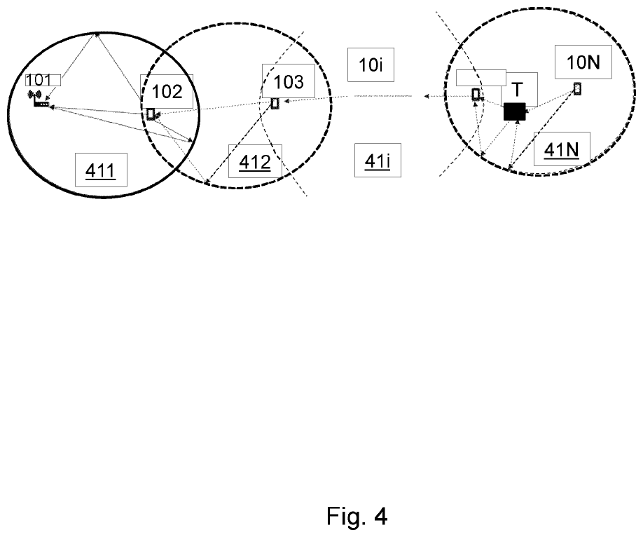

According to some embodiments herein, the sensing approaches described above may also apply to a scenario when the first, second and third network nodes 101, 102, 103 belong to the same network. This scenario is shown in FIG. 3. In this figure, the solid circle 310 represents the communication coverage area of the first network node 101, while the dashed circle 320 represents the sensing coverage area of the first network node 101. It is further assumed that the second network node 102 has a stronger channel towards the first network node 101, compared to the corresponding channel between the first and third network nodes 101, 103. In this case, given that the achieved SNR is sufficiently high, both the AP and the STAs can establish communication links. However, in general, sensing with sufficient resolution requires higher SNR. There might be cases when the third network node 103 is close to the edge of the sensing coverage of the first network node 101 and the second network node 102 is placed somewhere in the middle of the propagation path between the third network node 103 and the first network node 101. In this case, the achieved sensing resolution might not be sufficient if sensing is undertaken using transmissions only from the second network node 102 or the third network node 103.

In order to increase the sensing resolution, whenever a sensing packet is transmitted from the third network node 103 to the first network node 101, the second network node 102 may amplify-and-forward the received signal from the third network node 103. In this way, a higher sensing SNR is achieved on the first network node 101.

Therefore, according to embodiments herein, it is proposed to overcome the previous limitation by forming a cooperative AF sensing from the third network node 103 to the first network node 101 via the second network node 102. In particular, when a sensing procedure is initiated by one of the available nodes, the third network node 103 transmits a sensing signal or sensing packet. During this packet transmission, the transmitted signal from the third network node, x₃(t) is received by the first network node 101. Also, it is received by the second network node 102 which relays it to the first network node following the AF approach. Consequently, the received signal in the first network node 101 is given as:

$${y}_{1} ( t ) = [ {h}_{1 , 3} ( t ) + {h}_{1 , 2 , 3} ( t - {t}_{0} ) ] * {x}_{3} ( t ) + {\overline{w}}_{1} ( t ) \qquad ( 8 )$$

In equation (8), h_{1,3}(t) denotes the direct channel from the third network node 103 to the first network node 101; h_{1,2,3}(t)=h_{1,2}(t)*h_{2,3}(t) denotes the virtual channel from the third network node 103 to the first network node 101 via the second network node 102, where, h_{1,2} (t), and h_{2,3} (t), are defined as above; to denotes the time delay between the direct channel from the first network node 101 to the third network node 103 and the virtual channel from the third network node 103 to the first network node 101 via the second network node 102, and w̅₁(t) is the Gaussian noise experienced by the first network node 101, defined as above. The observation of equation (8) reveals that it has the same structure as equation (1). This is because h̅(t)=h_{1,3} (t)+h_{1,2,3} (t), can be interpreted as a virtual channel. Therefore, the first network node 101 can apply in the received signal of equation (8) any bistatic CSI sensing method available. It is clear that the architecture of FIG. 3 provides SNR enhancement compared to the case where only the third network node 103 is used for transmitting sensing signals. Specifically, the first term h_{1,3} (t), which corresponds to the experienced channel without a relay, is typically much weaker than the second channel h_{1,2,3} (t), which is the additional channel obtained through the use of the relay. Therefore, typically, the channel that is used for sensing is considerably stronger in case a relay is used.

Therefore, the first network node 101 may further be configured to determine whether there is a change in the physical environment based on the estimated CSI for a direct channel between the first and N-th network nodes in addition to the estimated CSI for the channel between the first and N-th network nodes via one or more relay nodes from the (N−1)-th network node to the second network node (102).

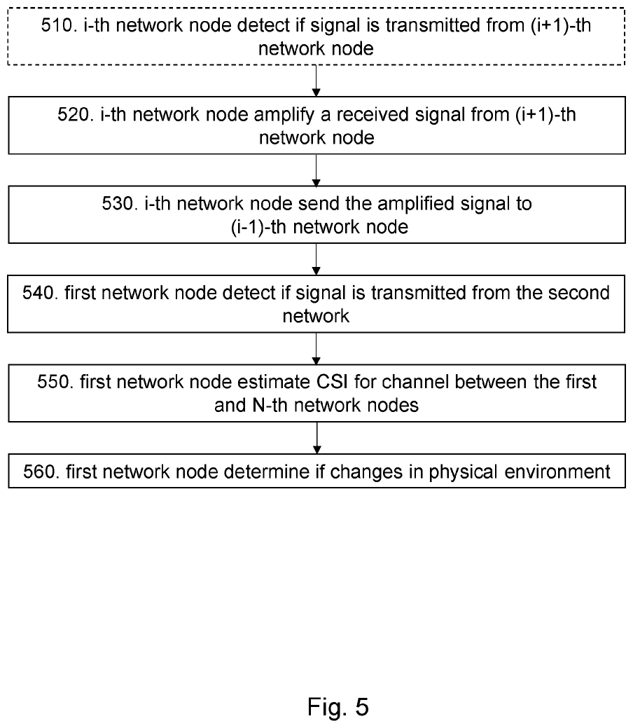

According to some embodiments herein, the approaches described above for extension the sensing coverage area may be extended to multi-hop sensing. FIG. 4 shows a multi-hop wireless sensing system 400 according to embodiments herein for detecting changes in a physical environment based on CSI. The wireless sensing system 400 comprises a number of N network nodes 101, 102, 103, 10i, . . . 10N, wherein the first network node 101 is a receiving node or a sensing receiver configured to detect changes in the physical environment, an i-th network node is a relaying node, where i=2, . . . . N−1, and the N-th network node is a transmitting node or sensing transmitter and configured to transmit a signal.

The first network node 101 to the (N−1)-th network node may be associated, while the N-th network node 10N may not be associated. The N network nodes 101, 102, 103, 10i, . . . 10N are spatially distributed in an area which is intended to be sensed. The solid circle 411 represents the sensing coverage cell of the first network node 101, while the i-th circle 41i, where i=2, . . . . N−1, represents the region from which the i-th network node can amplify-and-forward to the (i−1)-th network node a received signal from the (i+1)-th network node with sufficient high SNR. In addition, the second network node 102 may be more capable than the other nodes. For example, the first network node could be an AP which aims to sense a distant target via the second network node 102 to the (N−1)-th network node which are STAs. Here, the assumption is that the first network node 101 to the (N−1)-th network nodes are associated to the same network, while, the N-th network node is not associated. This means that the first network node 101 to the (N−1)-th network node can coordinate their transmission. Consequently, whenever the first network node 101 needs to sense the vicinity covered by the second network node 102 to the (N−1)-th network node, it can initiate an AF sensing procedure. In particular, upon the initiation from the first network node 101, the (N−1)-th network node transmits a packet which is amplified and forwarded by the (N−2)-th network node. This is repeated until the packet reaches the first network node 101. The received signal in the first network node 101 is expressed:

$${y}_{1} ( t ) = {h}_{1 , 2} ( t ) * ⋯ * {h}_{N - 2 , N - 1} ( t ) * {x}_{N - 1} ( t ) + {w}_{1 , N - 1} ( t ) \qquad ( 9 )$$

where, w_{1,N-1} (t), represents the Gaussian noise in the first network node 101 plus the noise amplification that occurs during each of multi-hop AF process from the (N−1)-th network node to the second network node 102. Similarly, as observed before, as equation (9) resembles to equation (1), the first network node can apply any known CSI sensing technique in the composite channel h₁,N−1 (t)=h_{1,2} (t)* . . . *h_{N-2,N-1}(t).

Apart from the case described above, the first network node might need to sense beyond the coverage area of the associated first to (N−1)-th network node in its network, for example in the coverage are of the N-th network node. As the N-th network is not part of its network, a direct initiation of sensing, as described before, is not possible. In this case, it can instruct the (N−1)-th network node to listen for any transmission of the non-associated N-th network node. Once this happens, the (N−1)-th network node can identify any known signal part such as beacon or LTF, amplify it, and then forwarded it to the (N−2)-th network node. This happens serially in the subsequent nodes until it reaches the first network node 101. In this case, the received signal in the first network node is:

$${y}_{1} ( t ) = {h}_{1 , 2} ( t ) * ⋯ * {h}_{N - 1 , N} ( t ) * {x}_{N} ( t ) + {w}_{1 , N} ( t ) \qquad ( 10 )$$

Where, w_{1,N}(t), represents the Gaussian noise in the first network node 101 plus the noise amplification that occurs during each of multi-hop AF process from the N-th network node to the second network node 102. Using the same observation as before, equation (10) has the form of equation (1). Therefore, the first network node 101 is able to apply the same CSI sensing processing in equation (10) as equation (1).

Finally, it is emphasized that even though the embodiments are presented for the case of single relaying node in each hope, the generalization to multiple node relaying per hop is easy. In particular, it can be shown that received signal in the first network node 101 is:

$${y}_{1} ( t ) = h ( t ) * x ( t ) + w ( t ) \qquad ( 11 )$$

with, h(t), being the virtual channel from the source node(s), i.e., the N-th node, to the first network node 101 via the intermediate nodes. Note that, even though in the hops between the source node(s) and the intermediate nodes there might be multi-input-multi-output (MIMO) channels between the nodes of a hop, in the last hop, the received signal y₁(t) is always a stream as there is only one receiving node.

A sensing procedure in the coverage area of the first network node to the (N−1)-th network node may be initiated and undertaken at any time. Whereas a sensing procedure in the N-th network node may not be initiated at any time from the first network node 101, it can be completed only after the independent signal transmission of a known signal such as a beacon or LTF, from the N-th network node 10N.

According to some embodiments herein, the N-th network node may be configured to transmit a signal upon a request received from the first network node 101 or any of the i-th network node, i=2, . . . . N−1.

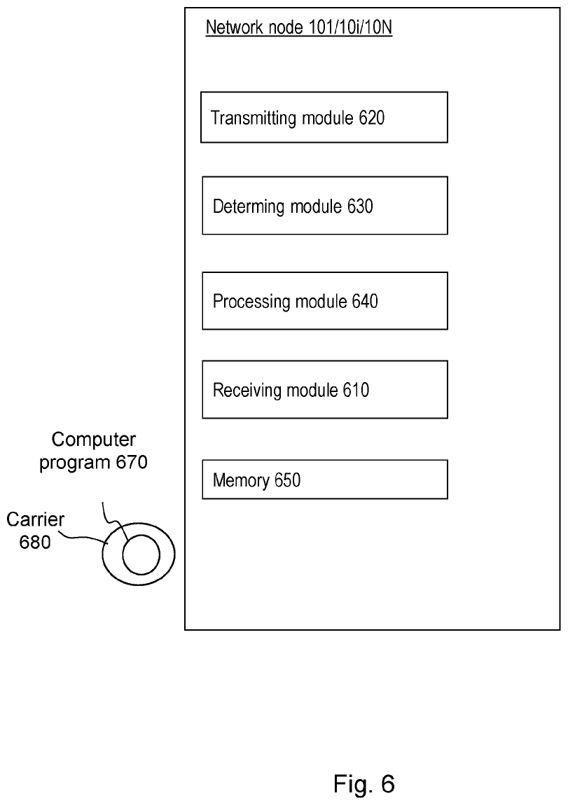

A method performed in the wireless sensing system 200, 300, 400 for detecting changes in a physical environment based on CSI according to embodiments herein will be describe with reference to FIG. 5.

As described above with reference to FIG. 4, the wireless sensing system 200, 300, 400 may comprise a number of N network nodes 101, 102, 103, . . . 10N, e.g. N=3. The first network node 101 is a receiving node or sensing receiver configured to detect changes in the physical environment. The i-th network node is a relaying node, i=2, . . . . N−1, and the N-th network node is a transmitting node or sensing transmitter and configured to transmit a signal. The method comprises the following actions:

### Action 510

The i-th network node 10i may detect, if any signal is transmitted from the (i+1)-th network node. For example, when N=3, there are only three network nodes 101, 102, 103 as shown in FIGS. 2 and 3, it is the second network node 102 detects if any signal is transmitted from the 3rd network node 103.

The i-th network node may be a detecting and relaying node, i.e. the i-th network node may detect if any signal is transmitted from the (i+1)-th network node by measuring a received signal strength and comparing the received signal strength with a threshold. If the received signal strength is larger than the threshold, the i-th network node starts AF operation.

The i-th network node may also be an all-time relaying node, i.e. the i-th network node may run AF operation all the time without explicitly detect if there is a signal. So the i-th network node may just amplify any signal that appears at its input without explicit detection and send the amplified signal to the (i−1)-th network node. If there is no signal at its input, then there will be no signal relayed by the i-th network node.

With all-time relaying, the relaying node can have a simple design, while with detecting and relaying, the relaying node can have energy efficiency.

The signal transmitted from the (i+1)-th network node may be a packet comprising a preamble or any known signal part transmitted to another network node or a beacon frame if the (i+1)-th network node is not associated with the i-th network node.

The signal transmitted from the (i+1)-th network node may be a dedicated packet transmission if the (i+1)-th network node is associated with the i-th network node.

If the N-th network node 10N is not associated with the (N−1)-th network node, the signal transmitted from the N-th network node 10N may be a packet comprising a preamble or any known signal part transmitted to another network node or a beacon frame.

If the N-th network node 10N is associated with the (N−1)-th network node, the signal transmitted from the N-th network node 10N is a dedicated packet transmission to the (N−1)-th network node.

### Action 520

The i-th network node 10i amplifies a received signal from the (i+1)-th network node. For example, when N=3, the second network node 102 amplifies a received signal from the third network node 103.

### Action 530

The i-th network node 10i sends the amplified signal to the (i−1)-th network node. For example, when N=3, the second network node 102 sends the amplified signal to the first network node 101.

### Action 540

The first network node 101 detects if any signal is transmitted from the second network node 102.

### Action 550

The first network node 101 estimates CSI for a channel between the first and N-th network nodes via one or more relay nodes from the (N−1)-th network node to the second network node 102 based on a received signal from the second network node 102. Since there is no direct channel from the N-th network node to the first network node 101, the channel between the first and N-th network nodes is a virtual channel and established via hopping or relaying by one or more intermediate or relay nodes, i.e., the one or more i-th network nodes, from the (N−1)-th network node to the second network node. In each hopping or relaying, the intermediate or relay node is configured to perform the actions 510-530 described above for the i-th network node. That is the first network node 101 estimates CSI for the channel between the first and N-th network nodes via one or more relay nodes from the (N−1)-th network node to the second network node based on the received signal from the second network node 102.

For example, when N=3, the first network node 101 estimates CSI for a channel between the first and third network nodes via the second network node 102 based on the received signal from the second network node 102.

### Action 560

The first network node 101 determines whether there is a change in the physical environment based on the estimated CSI for the channel between the first and N-th network nodes. For example, when N=3, the first network node 101 determines whether there is a change in the physical environment based on the estimated CSI for the channel between the first and third network nodes via the second network node 102.

To perform the method in the network nodes 101, 102, . . . 10i, . . . 10N, the network node 101/10i/10N comprises modules as shown in FIG. 6. The network node 101/10i/10N comprises a receiving module 610, a transmitting module 620, a determining module 630, a processing module 640, a memory 650 etc.

The network nodes 101, 102, . . . 10i, . . . 10N are configured to perform corresponding method Actions 510-560 described above.

The i-th network node may be configured to, by means of e.g., the receiving module 610 and determining module 630 being configured to, detect if any signal is transmitted from the (i+1)-th network node.

The i-th network node is further configured to, by means of e.g., the processing module 640 being configured to, amplify a received signal from the (i+1)-th network node.

The i-th network node is further configured to, by means of e.g., the transmitting module 620 being configured to, send the amplified signal to the (i−1)-th network node.

The first network node 101 is configured to, by means of e.g., the processing module 640 being configured to, detect if any signal is transmitted from the second network node 102.

The first network node 101 is further configured to, by means of e.g., the processing module 640 being configured to, estimate CSI for the channel between the first and N-th network nodes based on the received signal from the second network nodes.

The first network node 101 is further configured to, by means of e.g., the determining module 630 being configured to, determine whether there is a change in the physical environment based on the estimated CSI for the channel between the first and N-th network nodes.

The method according to embodiments herein may be implemented through one or more processors together with computer program code for performing the functions and actions of the embodiments herein. The program code mentioned above may also be provided as a computer program product, for instance in the form of computer readable medium or a data carrier 680 carrying computer program code 670, as shown in FIG. 6, for performing the embodiments herein when being loaded into the network node 101/10i/10N. One such carrier may be in the form of a CD ROM disc. It is however feasible with other data carriers such as a memory stick. The computer program code may furthermore be provided as pure program code on a server or a cloud and downloaded to the network node 101/10i/10N.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appended claims.

1. A wireless sensing system for detecting changes in a physical environment based on Channel State Information, CSI, the wireless sensing system comprising a number of N network nodes, a first network node being a receiving node configured to detect changes in the physical environment, an i-th network node being a relaying node, i=2, . . . N−1, and an N-th network node being a transmitting node, the i-th network node being configured to:
amplify a received signal from the (i+1)-th network node; and
send the amplified signal to the (i−1)-th network node; and
the first network node being configured to:
detect if any signal is transmitted from the second network node;
estimate CSI for a channel between the first and N-th network nodes via one or more relay nodes from the (N−1)-th network node to the second network node based on the received signal from the second network node; and
determine whether there is a change in the physical environment based on the estimated CSI for the channel between the first and N-th network nodes.

2. The wireless sensing system according to claim 1, wherein the i-th network node is further configured to detect if any signal is transmitted from the (i−1)-th network node.

3. The wireless sensing system according to claim 1, wherein the first to (N−1)-th network nodes are associated and the N-th network node is not associated with the (N−1)-th network node, and the signal transmitted from the N-th network node is a packet comprising a preamble or any known signal part transmitted to another network node or a beacon frame.

4. The wireless sensing system according to claim 1, wherein the N-th network node is associated with the (N−1)-th network node, and the signal transmitted from the N-th network node is a dedicated packet transmission to the (N−1)-th network node.

5. The wireless sensing system according to claim 1, wherein the number of N network nodes belong to the same network.

6. The wireless sensing system according to claim 5, wherein the first network node is further configured to determine whether there is a change in the physical environment based on the estimated CSI for a direct channel between the first and N-th network nodes in addition to the estimated CSI for the channel between the first and N-th network nodes via one or more relay nodes from the (N−1)-th network node to the second network node.

7. The wireless sensing system according to claim 1, wherein the i-th network node is further configured to receive a request from the first network node or from the (i−1)-th network node to start detecting if any signal is transmitted from the (i+1)-th network node.

8. The wireless sensing system according to claim 1, wherein the N-th network node is configured to transmit a signal upon a request received from the first network node or any of the i-th network node, i=2, . . . N−1.

9. The wireless sensing system according to claim 1, wherein N=3 and i=2.

10. A method performed in a wireless sensing system for detecting changes in a physical environment based on Channel State Information, CSI, the wireless sensing system comprising a number of N network nodes, a first network node being a receiving node configured to detect changes in the physical environment, an i-th network node being a relaying node, i=2, . . . N−1, and an N-th network node being a transmitting node and configured to transmit a signal, the method comprising:
amplifying by the i-th network node, a received signal from the (i+1)-th network node;
sending by the i-th network node, the amplified signal to the (i−1)-th network node;
detecting by the first network node, if any signal is transmitted from the second network node;
estimating by the first network node, CSI for a channel between the first and N-th network nodes via one or more relay nodes from the (N−1)-th network node to the second network node based on the received signal from the second network node; and
determining by the first network node, whether there is a change in the physical environment based on the estimated CSI for the channel between the first and N-th network nodes.

11. The method according to claim 10, further comprising detecting by the i-th network node, if any signal is transmitted from the (i+1)-th network node.

12. The wireless sensing system according to claim 2, wherein the first to (N−1)-th network nodes are associated and the N-th network node is not associated with the (N−1)-th network node, and the signal transmitted from the N-th network node is a packet comprising a preamble or any known signal part transmitted to another network node or a beacon frame.

13. The wireless sensing system according to claim 2, wherein the N-th network node is associated with the (N−1)-th network node, and the signal transmitted from the N-th network node is a dedicated packet transmission to the (N−1)-th network node.

14. The wireless sensing system according to claim 2, wherein the number of N network nodes belong to the same network.

15. The wireless sensing system according to claim 14, wherein the first network node is further configured to determine whether there is a change in the physical environment based on the estimated CSI for a direct channel between the first and N-th network nodes in addition to the estimated CSI for the channel between the first and N-th network nodes via one or more relay nodes from the (N−1)-th network node to the second network node.

16. The wireless sensing system according to claim 2, wherein the i-th network node is further configured to receive a request from the first network node or from the (i−1)-th network node to start detecting if any signal is transmitted from the (i+1)-th network node.

17. The wireless sensing system according to claim 2, wherein the N-th network node is configured to transmit a signal upon a request received from the first network node or any of the i-th network node, i=2, . . . N−1.

18. The wireless sensing system according to claim 2, wherein N=3 and i=2.

19. The wireless sensing system according to claim 3, wherein the i-th network node is further configured to receive a request from the first network node or from the (i−1)-th network node to start detecting if any signal is transmitted from the (i+1)-th network node.

20. The wireless sensing system according to claim 3, wherein the N-th network node is configured to transmit a signal upon a request received from the first network node or any of the i-th network node, i=2, . . . N−1.
